(19) United States
(12) Patent Application Publication
(10) Pub. No.: US 2018/0060472 A1
(43) Pub. Date: Mar. 1, 2018

(54) EFFICIENT CELL-AWARE FAULT MODELING BY SWITCH-LEVEL TEST GENERATION

(71) Applicant: MediaTek Inc., Hsin-Chu (TW)

(72) Inventor: Harry Hai Chen, Hsinchu City (TW)

(73) Assignee: MediaTek Inc., Hsin-Chu (TW)

(21) Appl. No.: 15/685,034

(22) Filed: Aug. 24, 2017

Related U.S. Application Data
(60) Provisional application No. 62/381,040, filed on Aug. 30, 2016.

(51) Int. Cl. G06F 17/50

(52) U.S. Cl. CPC G06F 17/5036; G06F 2217/02

(57) ABSTRACT

A circuit modeling method, computer readable medium and apparatus for automatic test pattern generation. An analog circuit representation of a circuit is received. A switch-level representation of the circuit is produced by replacing analog circuit elements of the analog circuit representation with switches and modeling faults in the circuit as switches.

### CROSS REFERENCE TO RELATED APPLICATIONS

This application claims the benefit of U.S. Provisional Application No. 62/381,040, titled “Efficient Cell-Aware Fault Modeling by Switch-Level Test Generation,” filed on Aug. 30, 2016, which is incorporated herein by reference in its entirety.

### BACKGROUND

### 1. Technical Field

The techniques described herein relate generally to producing a switch-level circuit model for automatic test pattern generation.

### 2. Discussion of the Related Art

Semiconductor chips may be tested to verify their operation. Testing of semiconductor chips entails applying numerous combinations of signal patterns by a testing device. Given the complexity of modern integrated circuits, the number of patterns that need to be tested may be in the thousands, hundreds of thousands or more. Automatic test pattern generation refers to generating the various permutations of test patterns to thoroughly test a chip. Test pattern generation relies on models of the on-chip circuitry to produce the appropriate test patterns for detecting various faults.

### SUMMARY

Some embodiments relate to circuit modeling method for automatic test pattern generation. An analog circuit representation of a circuit is received. A switch-level representation of the circuit is produced by replacing analog circuit elements of the analog circuit representation with switches and modeling faults in the circuit as switches.

Some embodiments relate to a non-transitory computer readable storage medium, which, when executed, perform such a method.

Some embodiments relate to an apparatus comprising a processor and a non-transitory computer readable storage medium, which, when executed, perform such a method.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 illustrates the process flow to produce a model used for automatic test pattern generation based on analog circuit simulations.

FIG. 2 shows a modified method that can significantly reduce or eliminate the need for analog circuit simulations.

FIG. 3 shows an example of the way in which the method of FIG. 2 may be performed.

FIG. 4 illustrates switch models for resistors, capacitors, short circuit faults and open circuit faults.

FIGS. 5A and 5B illustrate a switch level model that can be used to model open-circuit faults (FIG. 5A) and short-circuit faults (FIG. 5B) for a 4-input AOI22 standard cell.

FIG. 5C shows the schematic diagram of an analog circuit representation of a NAND2 cell.

FIG. 6 shows a channel connected network of an AOI22 CMOS cell.

FIG. 7 shows the CCN-open circuit model.

FIG. 8 shows CCN-open Vₒ(t) plots over full range of defect resistance ρ.

FIG. 9 shows the resistor network associated with this interconnect along with the p component values.

FIG. 10 depicts the CCN-short defect test condition.

FIG. 11 shows CCN-short Vₒ(t) plots over full range of defect resistance ρ.

FIG. 12 shows the result of analog simulation for a 2-cycle transition pattern to test AOI22 bridging fault #12 between nodes C and D in FIG. 5B.

FIG. 13 is a block diagram of an illustrative computing device.

### DETAILED DESCRIPTION

The techniques described herein relate to fault models that can be used to produce test patterns to test a digital circuit. The present inventor has recognized and appreciated that prior models either failed to capture behaviors of the digital circuit that needed to be tested, or required excessive processing capabilities due to models that required extensive analog simulations. “Gate level” fault models have been used to model logic gates for the purposes of test pattern generation. However, as technology progresses and transistor sizes continue to decrease, analog circuit effects become more prominent, and gate level fault models may not be sufficient to account for various types of faults. As a result, the test patterns that are generated are not designed to test for such faults, and chips may not be adequately tested.

To address this problem, analog circuit simulations have been used to provide higher modelling accuracy. However, performing analog circuit simulations to model a complex modern integrated circuit may be prohibitive in computational complexity, and may take weeks or months to perform. In some embodiments, switch-level fault models can have improved accuracy over gate level fault models and reduced computational complexity with respect to analog circuit simulations.

Digital circuit designers may take advantage of defined libraries of cells. A “cell” may be a basic digital circuit building block such as a multiplexer, logic gate, etc. Rather than designing such building blocks from scratch each time they are needed, a circuit designer may select an appropriate cell from the library having suitable characteristics such as output drive capability, power consumption, area, etc. In order to appropriately test digital circuits, a fault model may be generated for each cell in the library. A fault model is a representation of the cell that takes into account the possibility of various types of faults at a number of locations within the cell. Examples of fault types that may be taken into account include inputs or outputs stuck at logic-0 or 1, for example. For instance, if a multiplexer has three inputs and one output, a gate level model of the multiplexer may take into account the possibility that one or more of the inputs or output is stuck at logic-0 or 1. Based on such a model, automatic test pattern generation may generate a sequence of test signals to test whether an instance of a multiplexer has these faults. However, it has been appreciated that such a gate-level model does not take into account all the faults that may occur within the cell, particularly as transistors become smaller in size and analog circuit effects become more prominent. Accordingly, a more accurate model is needed.

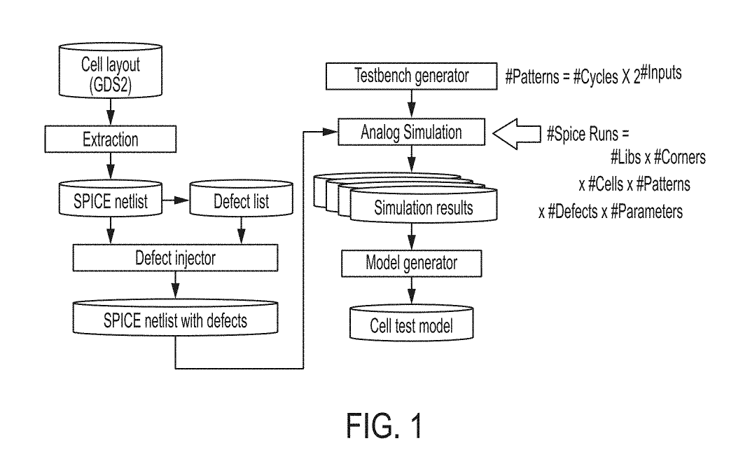

FIG. 1 illustrates the process flow to produce a model used for automatic test pattern generation based on analog circuit simulations. Cell layout and extraction may be performed. Based on the extracted layout, the parasitics (e.g., parasitic resistance, capacitance and/or inductance) may be determined. Based on the parasitics, a circuit representation may be produced. As an example, a netlist (e.g., a SPICE netlist) may be generated. The circuit representation is then updated to include one more defects to be tested. For each defect, an analog circuit simulation is run (e.g. in an analog circuit simulation tool, such as HSPICE, for example) for various combinations of inputs and analog input levels to determine the effect the defect has for each combination. Based on the simulation results, a model of the cell is generated that can be used for automatic test pattern generation.

The inventor has recognized and appreciated that performing the analog circuit simulations is a bottleneck, and can take weeks or months to run for all the cells in library. The “Testbench generator” block generates all possible input conditions. For example, a 4-input cell would result in 32 2-cycle patterns being generated. A single cell library with 3 corners, 200 cells, average 32 patterns per cell, 200 defects per cell, and 3 parameters per defect would result in 11,520,000 SPICE runs. At 2 seconds per SPICE run, it would take 267.7 days to process the library. To process the library in 7 days, 38 SPICE licenses would be needed to run 38 jobs in parallel in the computing farm.

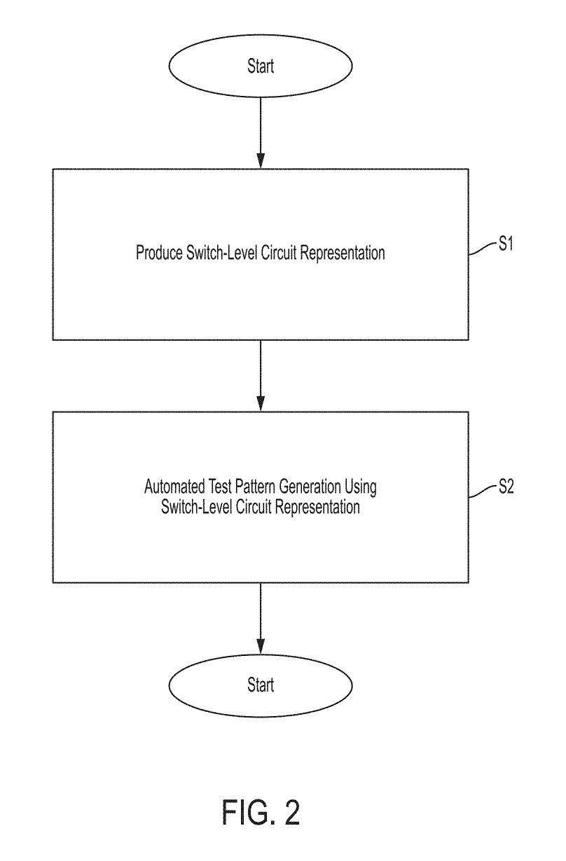

FIG. 2 shows a modified method that can significantly reduce or eliminate the need for analog circuit simulations. In step S1, a switch-level circuit representation can be produced including one or more defects. The switch-level circuit representation may account for most, if not all, defects, allowing the number of analog circuit simulations to be reduced or eliminated. In step S2, the switch-level circuit representation may then be used for automatic test pattern generation. In some embodiments, the method of FIG. 2 requires less than 0.25% of the computation needed by the method of FIG. 1.

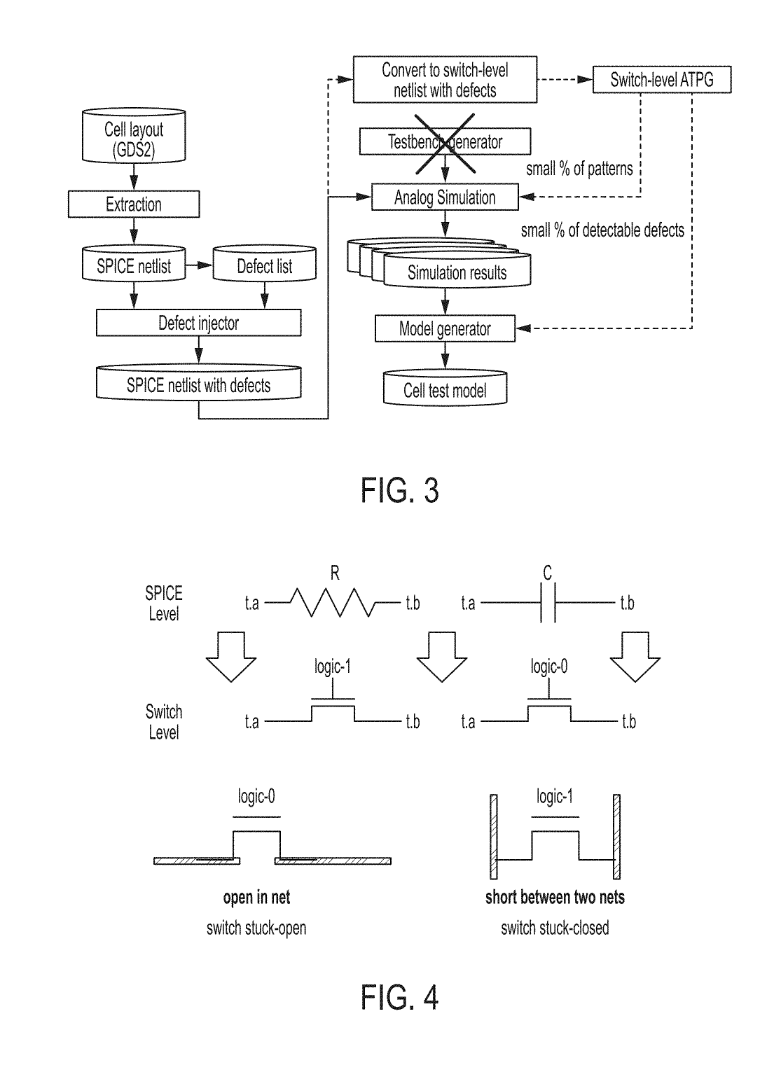

FIG. 3 shows an example of the way in which the method of FIG. 2 may be performed. In the example of FIG. 3, a circuit representation including parasitics and faults is converted into a switch-level circuit representation. The parasitics and faults that were represented by their analog circuit representations, such as capacitors and resistors, are converted into switches having suitable gate drive signals. For example, as illustrated in FIG. 4, a resistor may be converted into a NMOS switch having a logic 1 applied to its gate, and a capacitor may be converted into an NMOS switch having a logic 0 applied to its gate. Alternatively, a PMOS switch may be used with the opposite logic value applied to its gate. FIG. 4 illustrates that faults can be modeled as switches stuck open or closed. A short circuit fault can be modeled as an NMOS switch having its gate tied to logic 1. An open-circuit fault can be modeled as an NMOS switch having its gate tied to logic 0. Alternatively, a PMOS switch may be used with the opposite logic value applied to its gate.

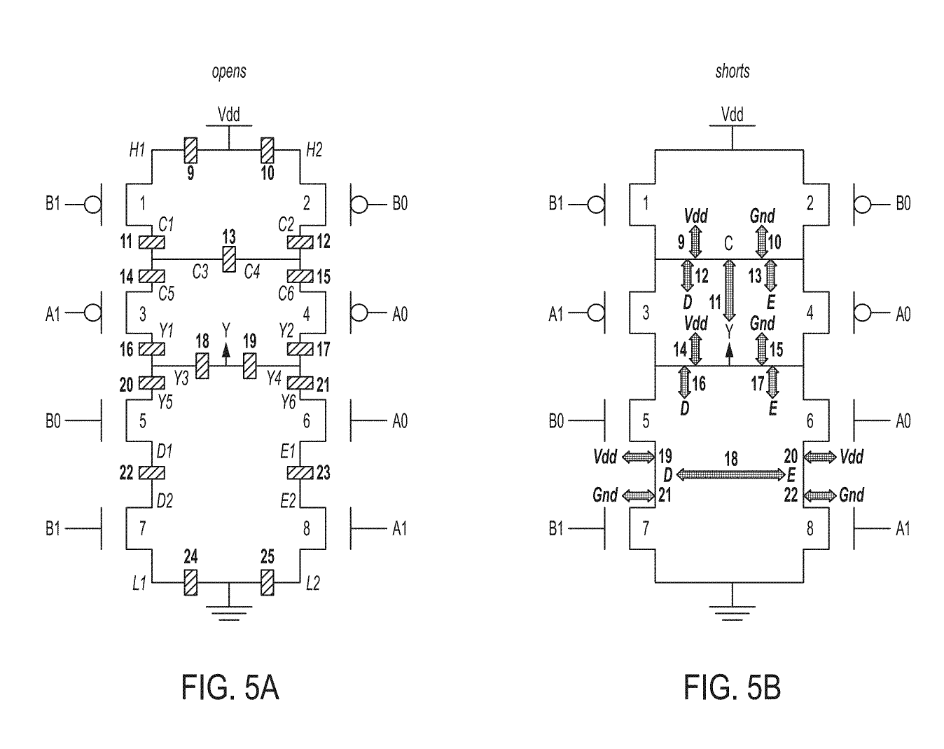

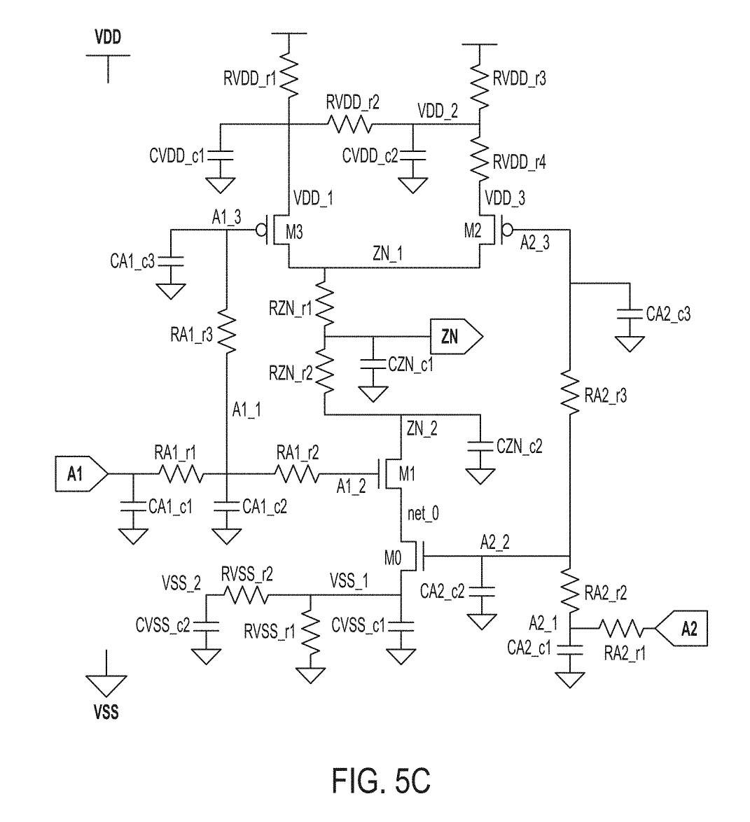

FIGS. 5A and 5B illustrate a switch level model that can be used to model open-circuit faults (FIG. 5A) and short-circuit faults (FIG. 5B) for a 4-input AOI22 standard cell. It should be appreciated that the techniques described herein are not limited to such a cell and can be applied to any suitable cell, portion of a cell, or combination of cells. FIG. 5A illustrates the locations at which the switch-level model of an open circuit fault (e.g., switch stuck open) may be inserted to account for open circuit faults throughout the cell. FIG. 5B illustrates the locations at which the switch-level model of a short circuit fault (e.g., switch stuck closed) may be inserted to account for short circuit faults throughout the cell.

One example of a circuit representation is a netlist. A netlist may include a textual representation of a circuit, such as the circuit components included and their interconnections. A netlist may be used by analog circuit simulation tools, such as SPICE, for example, to perform simulations with various input parameters. An analog circuit representation may be a netlist that describes the interconnections between analog circuit elements such as capacitors, resistors and transistors. In some embodiments, converting an analog circuit representation may include replacing the capacitors and resistors in the analog circuit representation with switches, as mentioned above. If an analog circuit representation includes a netlist, converting the netlist into a switch-level representation can be performed by replacing the netlist representation of the resistors and capacitors with switches. As an example, the text in the netlist representing resistors and capacitors may be replaced with text representing switches having their inputs tied to a suitable logic level. In some embodiments, the conversion may be performed automatically by software having instructions, which, when executed, replace the text in the netlist representing resistors and capacitors with text representing switches having their inputs tied to a predetermined logic level. A similar conversion may be performed for faults represented as resistors or capacitors. A more detailed example of converting an analog circuit representation into a switch-level circuit representation will now be described.

TABLE 1
SPICE NETLIST OF NAND2 CELL

.SUBCKT NAND2 VDD VSS ZN A1 A2
* .PININFO VDD:P VSS:G ZN:O A1:I A2:I
* .EQN ZN = !(A1 * A2)
* MOS transistor <drain> <gate> <source> <bulk>
M0 net_0 A2_2 VSS_1 VSS NMOS
M1 ZN2 A1_2 net_0 VSS NMOS
M2 ZN_1 A2_3 VDD_3 VDD PMOS
M3 ZN_1 A1_3 VDD_1 VDD PMOS
* Power supply VDD parasitic R and C
RVDD_r1 VDD_1 VDD
RVDD_r2 VDD_1 VDD_2
RVDD_r3 VDD_2 VDD
RVDD_r4 VDD_2 VDD_3
CVDD_c1 VDD_1 VSS
CVDD_c2 VDD_2 VSS
* Power ground VSS parasitic R and C
RVSS_r1 VSS_1 VSS
RVSS_r2 VSS_1 VSS_2
CVSS_c1 VSS_1 VSS
CVSS_c2 VSS_2 VSS
* Output ZN parasitic R and C
RZN_r1 ZN_1 ZN
RZN_r2 ZN_2 ZN
CZN_c1 ZN VSS
CZN_c2 ZN_2 VSS
* Input A1 parasitic R and C
RA1_r1 A1 A1_1
RA1_r2 A1_1 A1_2
RA1_r3 A1_1 A1_3
CA1_c1 A1 VSS
CA1_c2 A1_1 VSS
CA1_c3 A1_3 VSS
* Input A2 parasitic R and C
RA2_r1 A2 A2_1
RA2_r2 A2_1 A2_2
RA2_r3 A2_2 A2_3
CA2_c1 A2_1 VSS
CA2_c2 A2_2 VSS
CA2_c3 A2_3 VSS
.END

As mentioned above, a netlist may represent electrical devices with terminals connected together by nets. For standard digital cells, the analog circuit netlist may include transistors, resistors, and capacitors. Transistors have 3 functional terminals (drain, gate, and source) with the 4th non-functional terminal (bulk) tied to a power supply rail. Wiring parasitics in the layout are extracted as 2-terminal resistors and capacitors. Each device has additional parameters that govern their electrical behavior which is used for accurate analog circuit simulation of the standard cell.

FIG. 5C shows the schematic diagram of an analog circuit representation of a NAND2 cell. The SPICE netlist is reproduced in Table 1. Analog parameters are not shown in the SPICE netlist because they are ignored in creating the switch-level netlist. The cell has 2 functional inputs {A1, A2} and 1 output {ZN}, and power supply rails {VDD, VSS}. There are 4 transistors {M*} with 2 of NMOS and 2 of PMOS type. There are 14 parasitic resistors {R*} and 12 parasitic capacitors {C*}. Each device terminal position in the textual netlist is occupied by a net name. Terminals that share the same net name are connected together. Excluding cell external ports {A1, A2, ZN, VDD, VSS}, there are 14 nets in the example cell.

The SPICE netlist can be converted to a simplified switch-level netlist as follows. Each transistor is converted to a logic switch of the same type (ignoring the bulk terminal). Each resistor is converted to an NMOS switch whose gate is tied to logic 1. Each capacitor is converted to an NMOS switch whose gate is tied to logic 0. The nets' mapping is unchanged and connects switch terminals in the switch-level netlist.

Table 2 shows netlist conversion of the NAND2 cell from SPICE to switch-level. Although SPICE analog parameters are ignored, switches have discrete conductance and nets have discrete capacitance strength values that govern their digital behavior in the switch-level simulation of the standard cell. Strength values are assigned according to the design style's operating principle. Eight strength values are sufficient to capture the behavior of most digital design styles. In the switch-level algebra defined by Bryant, the strongest input strength ω is assigned to power supply rails while the weakest strength λ is the algebra's NULL element. For digital CMOS circuits, NMOS and PMOS switches have the same conductance strength γ2. Resistor and capacitor switches have conductance strength γ3 (for defect modeling). All nets have capacitance strength κ2, except for cell outputs which are assigned κ3. Cell inputs are assigned ω. The eight strength values and ordering from strongest to weakest are:

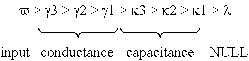

Various types of defects are associated with the electrical devices in SPICE. A “stuck-open” transistor is unable to turn on fully as in the normal case. A “stuck-closed” transistor is unable to turn off fully as in the normal case. An “open” wire segment in the layout means higher than normal resistance in the corresponding parasitic resistor. A “short” between two distinct wire segments in the layout means a resistive bridge across the terminals of the corresponding parasitic capacitor.

Equivalent switch-level defects may be obtained as follows. A “stuck-open” transistor maps to a switch that cannot conduct signal between drain & source. Above this is referred to as a switch stuck-open fault. A “stuck-closed” transistor maps to a switch that cannot cut off drain-source signal conduction. Above this is referred to as a switch stuck-closed fault. An “open” parasitic resistor maps to a stuck-open fault of the corresponding NMOS switch whose gate is tied to logic-1. A “short” across a parasitic capacitor maps to a stuck-closed fault of the corresponding NMOS switch whose gate is tied to logic 0. Note that analog defects can have a range of parameter values (for example, parameter values {1 ohm, 1 K-ohm, 1 M-ohm} for a resistive short defect). The corresponding switch-level defects do not need such parameter values since their purpose is to serve as seed objectives for switch-level test generation (SL-ATPG).

Referring again to FIG. 2, once a switch-level circuit model is generated, it can be used for automated test pattern generation. In the conventional cell-aware fault modeling flow, candidate patterns applied to the cell inputs are simulated in SPICE (slow analog simulator), once in defect-free case, and once for each defect and associated defect parameter value. The difference in cell output responses are compared between the defect-free and defect-injected cases to determine if the candidate pattern can detect the defect and its associated parameter value as an output stuck-at or transition delay fault. A defect-detecting pattern so determined becomes part of the cell-aware fault model. In the defect matrix, each entry consists of the cell input pattern, the output fault type (stuck-at or transition delay), and the corresponding detected defects. SL-ATPG obtains useful input patterns directly without going through the “trial-and-error” process of the conventional flow by targeting equivalent switch-level defects. SL-ATPG uses well-known and efficient test generation techniques (such as from PODEM) to direct the search for useful input patterns. The search process involves using switch-level simulation (orders of magnitude faster than analog simulation) to guide how cell inputs should be assigned, i.e., which inputs, what logic values. If no useful input patterns could be found, SL-ATPG identifies the defect as undetectable. Using additional knowledge of circuit properties associated with the design style, the output fault model can be inferred directly for many types of defects. In some cases, analog fault simulation of a judiciously chosen defect parameter value (based on circuit theory) may be used to validate the cell-aware fault model.

TABLE 2

# CELL NAND2 VDD VSS ZN A1 A2
# PINS VDD:P VSS:G ZN:O A1:I A2:I
# EQN ZN = !(A1 * A2)
# <MOS type> <conductance> <gate> <drain> <source> <name>
n 2 A2_2 net_0 VSS_1 M0
n 2 A1_2 ZN2 net_0 M1
p 2 A2_3 ZN_1 VDD_3 M2
p 2 A1_3 ZN_1 VDD_1 M3
# Power supply VDD parasitic R and C
n 3 VDD VDD_1 VDD RVDD_r1
n 3 VDD VDD_1 VDD_2 RVDD_r2
n 3 VDD VDD_2 VDD RVDD_r3
n 3 VDD VDD_2 VDD_3 RVDD_r4
n 3 VSS VDD_1 VSS CVDD_c1
n 3 VSS VDD_2 VSS CVDD_c2
* Power ground VSS parasitic R and C
n 3 VDD VSS_1 VSS RVSS_r1
n 3 VDD VSS_1 VSS_2 RVSS_r2
n 3 VSS VSS_1 VSS CVSS_c1
n 3 VSS VSS_2 VSS CVSS_c2
* Output ZN parasitic R and C
n 3 VDD ZN_1 ZN RZN_r1
n 3 VDD ZN_2 ZN RZN_r2
n 3 VSS ZN VSS CZN_c1
n 3 VSS ZN_2 VSS CZN_c2
* Input A1 parasitic R and C
n 3 VDD A1 A1_1 RA1_r1
n 3 VDD A1_1 A1_2 RA1_r2
n 3 VDD A1_1 A1_3 RA1_r3
n 3 VSS A1 VSS CA1_c1
n 3 VSS A1_1 VSS CA1_c2
n 3 VSS A1_3 VSS CA1_c3
* Input A2 parasitic R and C
n 3 VDD A2 A2_1 RA2_r1
n 3 VDD A2_1 A2_2 RA2_r2
n 3 VDD A2_2 A2_3 RA2_r3
n 3 VSS A2_1 VSS CA2_c1
n 3 VSS A2_2 VSS CA2_c2
n 3 VSS A2_3 VSS CA2_c3
# continued to nets
# <input> <name>
# Power rail and cell inputs
i VDD
i VSS
i A1
i A2
# <net> <capacitance> <name>
# VDD nets
s 2 VDD_1
s 2 VDD_2
s 2 VDD_3
# VSS nets
s 2 VSS_1
s 2 VSS_2
# ZN nets
s 3 ZN
s 2 ZN_1
s 2 ZN_2
# A1 nets
s 2 A1_1
s 2 A1_2
s 2 A1_3
# A2 nets
s 2 A2_1
s 2 A2_2
s 2 A2_3
# END NAND2 switch-level netlist

### APPENDIX

This application describes techniques that can drastically reduce the expensive analog fault simulation currently used to create cell-aware fault models. By exploiting low-power properties of common CMOS designs, most defects in the transistor-level netlist containing parasitics can be represented by just two canonical fault classes. Using circuit analysis, we show that faulty behaviors are completely predictable as the defect resistance parameter value varies from zero to infinity, thus eliminating the need for circuit simulation at multiple parameter values. The two canonical fault classes can be modeled by transistor switch stuck-open and stuck-closed faults. Rather than enumerating the full combination cell input patterns to search for defect detection conditions by analog fault simulation, switch-level test generation can obtain those input conditions directly, thereby reducing significantly the role of analog simulation to that of ranking conditions in terms of detection effectiveness.

### Section I.

### Introduction

The digital portion of today's complex system-on-chip (SoC) is predominantly constructed from a technology library of pre-defined standard cells using an automated RTL-to-GDS tools-chain flow. Each cell implements a logic function offered in a variety of output drive configurations. Cell functions range from simple to complex and cover both combinational and sequential behaviors. The logic synthesis tool maps the design's RTL description to a netlist of interconnected standard cells. Additional tools then perform further optimizations on the netlist to meet area, timing, power, and test goals as the design implementation is transformed into physical mask layers for fabrication.

For testing, scan design-for-test (DFT) methodology enables automatic test pattern generation (ATPG) to target faults defined on the cell I/O pins and interconnecting nets. Typical fault models include stuck-at (SAF), transition delay (TDF), and interconnect bridges. Motivated to achieve even higher quality, cell-aware testing (CAT) has been introduced recently to enhance coverage of defects occurring inside standard cells. Even though each standard cell is implemented by transistors, previous ATPG tools could only work with a functionally equivalent Boolean gate-level representation of the same cell. Thus for CAT, defects occurring at the transistor-level have to be somehow mapped to the gate-level. Such a task has been described as technology-dependent CAT view generation.

During CAT view generation, each defect is injected into the cell's SPICE netlist and analog simulation is performed to find all cell input conditions that could produce a SAF or TDF effect at one or more cell outputs. The set of input conditions and output fault effects then becomes the so-called user-defined fault model (UDFM) which is passed to gate-level ATPG for full-chip processing. At the gate-level. UDFM extends existing SAF and TDF models by introducing logic constraints on additional cell input pins to better reflect knowledge about how each internal defect in the transistor implementation can affect the cell's outward behavior.

Even though CAT view generation for a technology library is a one-time characterization effort, it still involves massive analog fault simulation runs that could take weeks to complete; or require an inordinate number of SPICE simulator licenses for parallel runs that ties up valuable computing resources needed for other design tasks. Furthermore, UDFM is a digital abstraction of analog fault effects, meaning much of the accurate details from analog simulation are not transferred because it would be impractical for the gate-level ATPG tool to fully consider them when design sizes are in the millions of gates. However, some analog information may be useful to improve the effectiveness of generated patterns. Lastly, for certain types of defects, stand-alone cell characterization may be inaccurate because the analog simulation fails to account for design context dependency at cell instance pins. This last point will be elaborated further in Section II-B.

This application addresses the deficiencies of CAT view generation identified above. Relying on two basic properties of CMOS standard-cell designs, it is shown that defects in the transistor channel-connected network can be grouped into two broad classes. All defects in the same class share a common test strategy and the same circuit model can be used to characterize defect behaviors by varying a single resistance parameter over its full range of values. Moreover, at most a single analog simulation at an extreme resistance value is sufficient to determine the defect's maximum impact under a particular input condition. By comparing maximum impacts, input conditions can be ranked in terms of their detection effectiveness. Such rankings can guide decision-making during gate-level ATPG.

In some embodiments, switch-level ATPG (SL-ATPG) is applied to reason about the underlying switching logic and to quickly identify all defect-detecting input conditions. In gate-level design, ATPG replaced stand-alone trial-and-error fault simulation because ATPG algorithms used knowledge of logic structures to efficiently search for useful input patterns. Similarly, SL-ATPG working on a simplified model of the transistor circuit is orders-of-magnitude more efficient than analog fault simulation of all enumerated input conditions along with transient analysis to check for defect detection. In searching for useful input conditions, defects in a class can be represented by stuck-open/off or stuck-closed/on switches for targeting by SL-ATPG. In the overall flow to generate CAT view, SL-ATPG may not replace analog fault simulation entirely, but it can take over those tasks that do not require analog circuit-level details. For example, SL-ATPG can quickly determine when conditions to sensitize a defect are logically impossible due to reconvergent fanout (most cell input ports fan out to NMOS and PMOS transistors that converge to the same channel-connected CMOS switch network). Analog fault simulation will need to try all enumerated conditions before reaching the same conclusion.

In this Appendix we use an AOI22 standard cell from a 16-nm FinFET technology library to convey the main ideas, which are further demonstrated by experimental results obtained from SL-ATPG and analog simulation. Section II introduces terminology and elaborates on key concepts related to switch-level modeling and testing. Sections III and IV analyze the canonical classes of “open” and “short” faults respectively, leading to insights that can make CAT view generation more efficient.

### Section II.

### Terminology and Concepts

### A. Channel-Connected Network

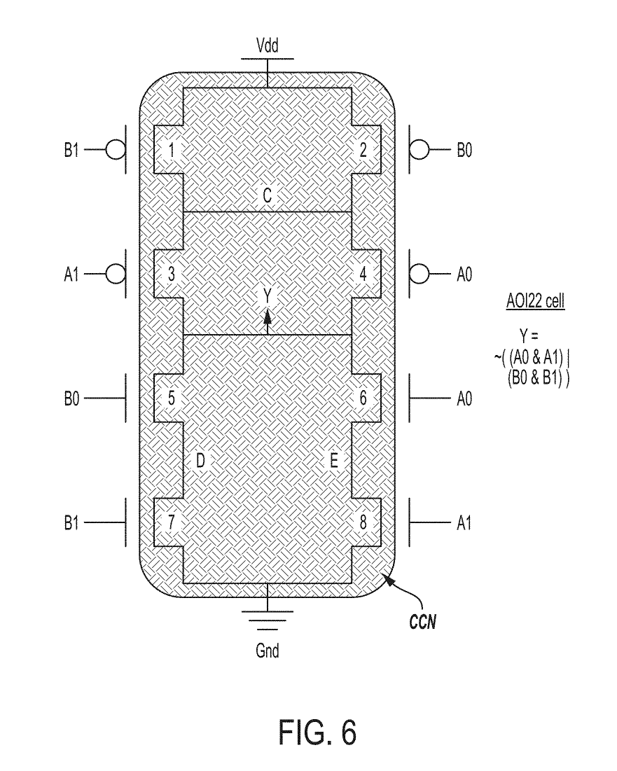

The basic transistor used in CMOS circuits is a three-terminal device. The gate (g) terminal controls current flow in the channel between source (s) and drain (d) terminals. Logically, the transistor is modeled as an ideal switch where for NMOS(PMOS),g=1(0) enables bidirectional signal flow in the channel, and g=0(1) cuts off signal flow. The following discussion uses the switch-level schematic of the AOI22 CMOS cell in FIG. 6 for illustration. Structurally, a channel-connected network (CCN) is comprised of switches (numbered 1 through 8) linked by their channels and nodes (labeled C, D, E, Y) joining channel terminals s and d. The CCN (shaded region) is bounded by power nodes Vdd and Gnd. Generally, power nodes connect many CCNs, but activities in the CCNs do not couple via the power nodes. CCN switch g terminals are driven by unidirectional inputs (A0, A1, B0, B1) and they determine the states of CCN nodes. Some CCN nodes are designated as outputs (Y) which generally feed g inputs of other CCNs.

In simulating design behavior. CCNs form a natural partitioning where signal changes flow from one CCN to the next via strictly unidirectional switch g inputs. Within a CCN, signals flowing across bidirectional channels are controlled by g inputs and an iterative algorithm is used to simultaneously solve for multiple node states. When one CCN feeds another via switch g inputs, a key aspect is that behaviors in the downstream CCN do not affect the upstream CCN unless there are explicit feedback signal paths in the design netlist.

### B. Design Context Dependency

The single CCN example in FIG. 6 matches a library cell exactly. But that is not always the case. Larger cells may contain multiple CCNs. e.g., a full-adder cell. More interestingly, a single CCN may also span multiple library cells. This situation arises with cells that use pass-switch logic implemented by CMOS transmission gates. Such a cell may have input ports that feed switch channel terminals directly. In the design, such cell instance pins will be driven by other cell instance outputs. Thus driving and receiving CCNs merge to form a single CCN in the design.

The formation of design-dependent CCN has significant implications on the accuracy of CAT view generation for certain defect types. Consider the case of PortBridge defect. In FIG. 6, assume input ports A1 and B0 are shorted together by a resistive bridge defect. In stand-alone CAT view generation, the analog simulation environment drives A1 and B0 with voltage sources. This is grossly inaccurate since in the design. A0 and B0 are driven by outputs of other cell instances. Through the bridge, these driving instance-specific CCNs merge into one and need to be simulated together to determine the correct voltages on the nodes connected to A1 and B0. The accurate voltages are then used to correctly simulate how the defect affects the behavior of the receiving CCN. Switch g-to-s/d bridge defects also face the same issue. If g is driven by an input port of the cell, the bridge merges the CCN driving g with the CCN containing the s-d channel. Every defect instance in the design will potentially create unique merged CCN configurations. Stand-alone cell defect characterization may not capture the unique design context-dependent behaviors accurately.

Defects that remain strictly within the same CCN have minimal or manageable design context dependencies associated with CCN output nodes. These may include: Open, Bridge, Tleak. and Tdrive. The rest of this Appendix will focus on these defect types.

### C. Switch-Level Model, Faults, and ATPG

Abstracting from the continuous domain to the discrete, switch-level modeling allows fast analysis of digital MOS circuit operation at the transistor level without incurring the full expense of analog simulation. The model captures important aspects such as bidirectional signal flow, relative conductance/capacitive strengths, charge storage/sharing, and robust timing behavior. By both extending formal switch-level algebra to handle decision choices and adapting PODEM ATPG's efficient branch-and-bound search strategy and heuristics, a SL-ATPG algorithm was developed to target switch stuck-open and stuck-closed faults. For stuck-open faults, the SL-ATPG tool can generate patterns spanning multiple time frames (up to a user-specified maximum) that are robust against corruption by timing hazards and charge-sharing.

The recent development of CAT has revived much interest to detect cell internal defects via more efficient test generation schemes. A common strategy among these works is to leverage existing Boolean algebraic methods by transformations into the gate-level domain preserving essential aspects of defect behaviors to be tested. However, these transformations assume fully complementary NMOS and PMOS switch network implementation of CMOS gates, which encounters practical limitations when cells employ alternative structures such as pass-switch logic. More subtle CCN behaviors affecting test quality may be lost in the translation as well. SL-ATPG is a more general and viable alternative that can handle a broader range of design situations with better implementation fidelity. With the exponential advance in computing power over the past thirty years. SL-ATPG can easily cope with circuit complexity at the scope of library cells or a few merged CCNs.

Though originally designed to target functional switches. SL-ATPG can readily treat faults associated with passive interconnects and parasitic R/C elements. For example, to model an open wire, replace the wire by a virtual NMOS switch whose channel s/d terminals match the two wire ends and tie the g terminal to logic-1 (normally always conducting). The open wire is then equivalent to the switch stuck-open fault. Similarly to model a bridge between two nodes, insert a virtual NMOS switch whose channel connects the two nodes and tie the g terminal to logic-0 (normally always disconnected). The bridge is then equivalent to the switch stuck-closed fault.

In FIG. 5A, open faults on 17 possible CCN wire segments (numbered 9 to 25) are shown in the AOI22 schematic. (Note new node labels due to node splits.) Targeting these along with the 8 switch stuck-open faults (numbered 1 to 8) under single fault assumption and optimistic treatment of charge-sharing. SL-ATPG generated robust 2-cycle patterns to achieve 100% coverage of all 25 faults.

The switch-level model assigns discrete and ranked capacitive strength levels. κ3>κ2>κ1, to each non-power node. When two nodes storing different logic values are connected by a switch, the node with the higher strength will dominate and propagate its value to the other node. In the previous SL-ATPG experiment, all non-power nodes are assigned κ2. Assigning κ3 to node Y will prevent corruption by charge-sharing at output Y. To assess worst-case charge-sharing. Y was lowered to κ2 for another SL-ATPG run with cycle count increased to 3 to allow extra “non-conflict” initializations of internal nodes. The result shows that 4 faults (locations 9, 10, 24, 25) became untestable, 11 faults (locations 1, 2, 7, 8, 11, 13, 14, 15, 20, 22, 23) required robust 3-cycle patterns, and 10 faults (locations 3, 4, 5, 6, 12, 16, 17, 18, 19, 21) remained robustly testable by 2-cycle patterns. These experiments demonstrate the benefit of SL-ATPG to quickly evaluate charge-sharing vulnerabilities. To do the same in analog simulation will increase the number of runs by a factor equal to all possible node initialization combinations, making it an untenable proposition.

FIG. 5B shows 14 possible node-pair bridging fault locations (numbered 9 to 22) involving the CCN node set {C, D, E, Y}. Adding the 8 switch stuck-closed faults (number 1 to 8) brings the total to 22. Ranked above capacitive strengths are switch conductance strength levels. γ3>γ2>γ1>κ's. The path conductance of a series-linked chain of switches rooted at a power node is the minimum conductance of the set. When two paths driven by different power node values converge at a non-power node, the higher strength path dominates, driving its value onto the node. Normally, both NMOS and PMOS functional switches are assigned γ2 since CMOS designs typically do not depend on conductance ratios. However, a bridging fault will cause drive conflicts between Vdd and Gnd conductance paths of equal strength resulting in the unknown value X at output Y (good/faulty=0/X or 1/X, soft detection at best). To generate patterns to achieve hard detection at Y (good/faulty=0/1 or 1/0), we make two SL-ATPG runs with all PMOS switches weakened in the first run and vice versa for NMOS switches in the second run. All non-functional bridging fault virtual switches are assigned γ3 to make their impacts felt.

In the first run with PMOS switches (numbered 1-4) weakened to γ1,16 faults (numbered 5-8, 10, 12-22) are detected. In the second run with NMOS switches (numbered 5-8) weakened to γ1,12 faults (numbered 1-4, 9-11, 13-15, 19-20) are detected. All generated patterns are 1-cycle and the consolidated fault coverage is 100% and 6 faults (numbered 10, 13, 14, 15, 19, 20) can be detected both times. As there are no known Boolean-based approaches to test all arbitrary bridging faults between CCN nodes. SL-ATPG offers an effective practical solution.

### D. Key CMOS Design Properties

Two key properties of low-power digital CMOS designs enable grouping of defects within a CCN into two canonical classes for general treatment. The properties hold true for any CCN implementing a combinational function.

P1—In steady state, all CCN outputs are always driven from either Vdd or Gnd; never both; never floating.

P2—In steady state, there is never a conducting path between Vdd and Gnd in the CCN.

Clearly, fully complementary NMOS and PMOS switch network implementations satisfy these properties. But these properties also hold true for all static CMOS designs including those that use pass-switch logic. The following sections analyze the two canonical fault classes referred to as “CCN-open” and “CCN-short”.

### Section III.

### CCN-Open Analysis

In the well-established 2-cycle scheme to test a CMOS transistor stuck-open fault, cycle-1 bypasses the faulty switch to initialize a CCN output to a known value, then cycle-2 drives the opposite value onto the output exclusively through the stuck-open switch. The fault is detected as a SAF in cycle-2 because in the faulty circuit, the output capacitor could not be charged or discharged thus retaining the initialized value. If TDF detection at the output is allowed, then we can extend this scheme to check for a delayed output transition time. i.e., slower capacitor charge/discharge rate in the faulty circuit. Since charge/discharge rate is proportional to the path's RC time constant, all defects along the path that increases resistance potentially can also be detected. These CCN-open defects comprise Tdrive and Open from which are physically associated with transistors and interconnect parasitic resistors respectively.

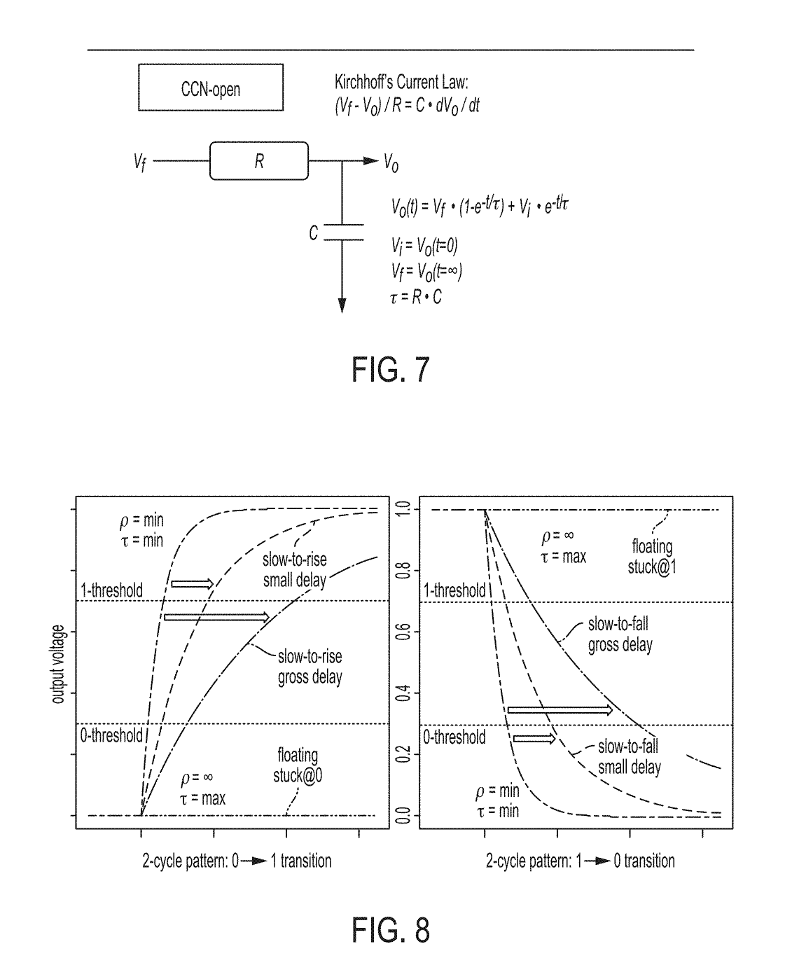

CCN-open testing can be characterized by the simple RC circuit model shown in FIG. 7, which shows the CCN-open circuit model. The circuit reflects the test condition in cycle-2 where Vₒ(t) is the output voltage in time starting from the end of initialization. R is the charge/discharge path resistance. C is the output capacitance. Vᵢ is the initialized voltage at the end of cycle-1. Vᵢ is the driving voltage for cycle-2. Lastly, τ governs the rate of output change.

Embedded in R is the defect resistance ρ ranging from a minimum value (no defect) to infinity (fully open). By CMOS design property P1, there are two possible cases:

C1—The defect is sensitized by a path charging the output to Vdd. Therefore, the 2-cycle test pattern must make Vₒ=1, i.e., Vᵢ=0(Gnd) and Vᵢ=1(Vdd).

C2—The defect is sensitized by a path discharging the output to Gnd. Therefore, the 2-cycle test pattern must make Vₒ=10, i.e., Vᵢ=1(Vdd) and Vᵢ=0(Gnd).

Plots of Vₒ (t) are shown for both cases in FIG. 8 as R varies from minimum to infinity illustrating various degrees of defect impact spanning minimal small-delay TDF to worst-case floating SAF. Based on our CCN-open analysis, the following key points can be made:

K1—TDF is the UDFM for all CCN-open defects since a transition is required and the floating SAF is just a special case of TDF where the delay is “forever”.

K2—CCN-open defects can be detected by transition patterns targeting proxy switch stuck-open faults.

K3—There is no need for analog simulation if SL-ATPG in K2 can find all robust multi-cycle transition patterns.

Regarding key point K3, analog simulation could have a role to preferentially rank patterns obtained by SL-ATPG. Since the actual value of defect resistance is unknown, one could choose a single moderately large p value to simulate each pattern with. By comparing delay size impact, patterns can be ranked for gate-level ATPG to choose, favoring those with the largest impact to enhance test effectiveness.

Lastly, in the CCN-open circuit model, output capacitance C does depend on design context in the form of instance-specific external fanout connections. However, the key conclusions drawn from CCN-open analysis do not depend on the actual value of C

Within the CCN-open class, defects associated with interconnect parasitic resistors deserve extra attention. In the extracted SPICE netlist of AOI122 cell, interconnect-related capacitors and resistors number 478 and 29 respectively. All are defect candidates taking up a large proportion of analog fault simulation time for that cell.

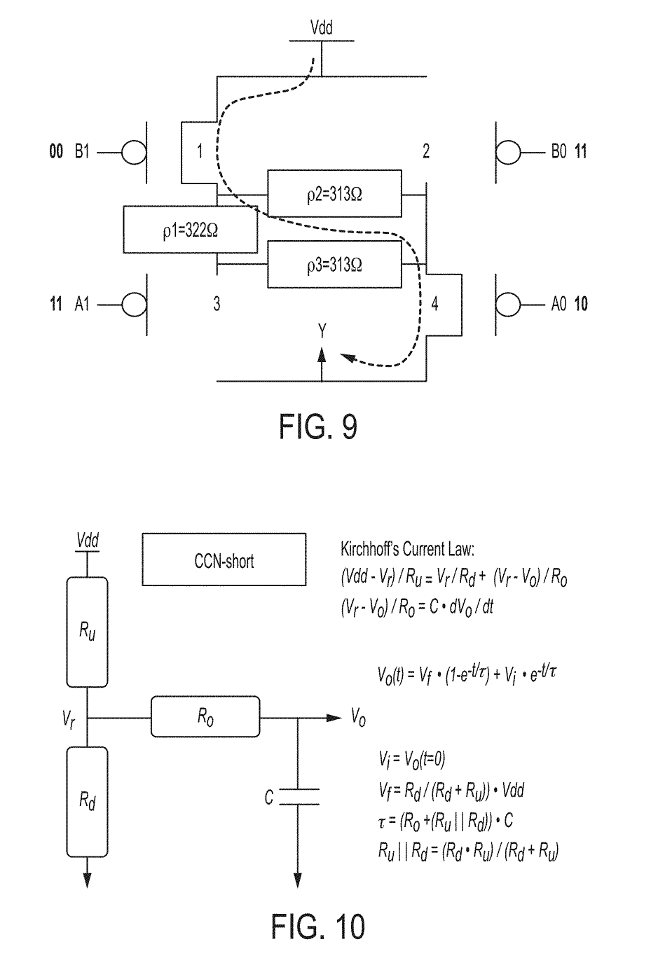

Consider interconnect open fault #13 in FIG. 5A. One possible 2-cycle test pattern is A0-A1-B0-B1=10-11-11-00. Expected output Y=01. FIG. 9 shows the resistor network associated with this interconnect along with the ρ component values. In cycle-2, Vdd charges Y via B1:p− channel, the ρ network, and A0:p− channel as indicated by the dotted line. With respect to the charging path, the ρ network resistance is 210Ω derived from ρ2 in parallel with ρ1+ρ3. When any one of the resistors has an open defect, the network resistance increases to at most 635Ω. With output Y capacitance of 1E−18 farads, impact on charging path time constant r is a miniscule addition of 0.425 femtoseconds. Since the charging delay did increase due to the open resistor, the theory of CCN-open testing is still valid. But under analog fault simulation, the practically indistinguishable difference would lead to wrongful test rejection. Wrongful because any opens at the entry or exit points of the resistor network could cause a detectable delay difference. Open fault #13 is an example of a “cross-wire open” which is important to detect. The real issue highlighted by this example is the risk of using parasitic elements as defect candidates. Given the frequent occurrence of parallel resistor structures, much wasteful analog simulation could result. One could argue that reducing all parasitics (short all resistors and open all capacitors) and applying SL-ATPG would lead to more effective patterns, and be done much quicker.

### Section IV.

### CCN-Short Analysis

CCN-short defects comprise Tleak and Bridge which are physically associated with transistors and interconnect parasitic capacitors, respectively. For a defect bridging two nodes inside a CCN, a necessary test condition is for the two nodes to be at opposite states; otherwise the defect's presence will not be apparent. Given opposite node states, the presence of the defect will create a conduction path between Vdd and Gnd. Along the path composed of resistors, nodes will have divided voltage values. For voltage detection of the defect at a CCN output, there needs to be an observable signal path from a node on the Vdd-Gnd path to that output.

The RC circuit model in FIG. 10 depicts the CCN-short defect test condition. Rᵤ (R_{d}) is the pull-up (down) resistor network with respect to node Vᵣ, and the observation path is from Vᵣ through Rₒ to output Vₒ. For generality, the test condition applies a 2-cycle pattern to allow TDF detection. Vₒ(t) is the output transient starting from the end of cycle-1. Vᵢ is the initial voltage at output capacitor C. V_{f} is the steady-state voltage reached at the end of cycle-2. Its value is derived from the resistive divider relationship of Rᵤ and R_{d}. Finally, τ determines the rate of output change.

By CMOS design property P2, the defect cannot exist in Rₒ; otherwise Rₒ and R_{d} constitutes a non-faulty Vdd to Gnd path. By CMOS design property P1 the defect exists either in Rᵤ or in R_{d} to enable a path to Vdd or Grind that should be normally non-conducting. There are two cases to consider:

C3—Defect is in R_{d}. The 2-cycle test pattern must make Vₒ=01. i.e., discharge output capacitor C in cycle-1 so that Vᵢ=0(Gnd). In cycle-2, charge C to Vdd while the defect creates a sneak discharge path to Gnd.

C4—Defect is in Rᵤ. The 2-cycle test pattern must make Vₒ=10, i.e., charge output capacitor C in cycle-1 so that Vᵢ=1(Vdd). In cycle-2, discharge C to Gnd while the defect creates a sneak charging path from Vdd.

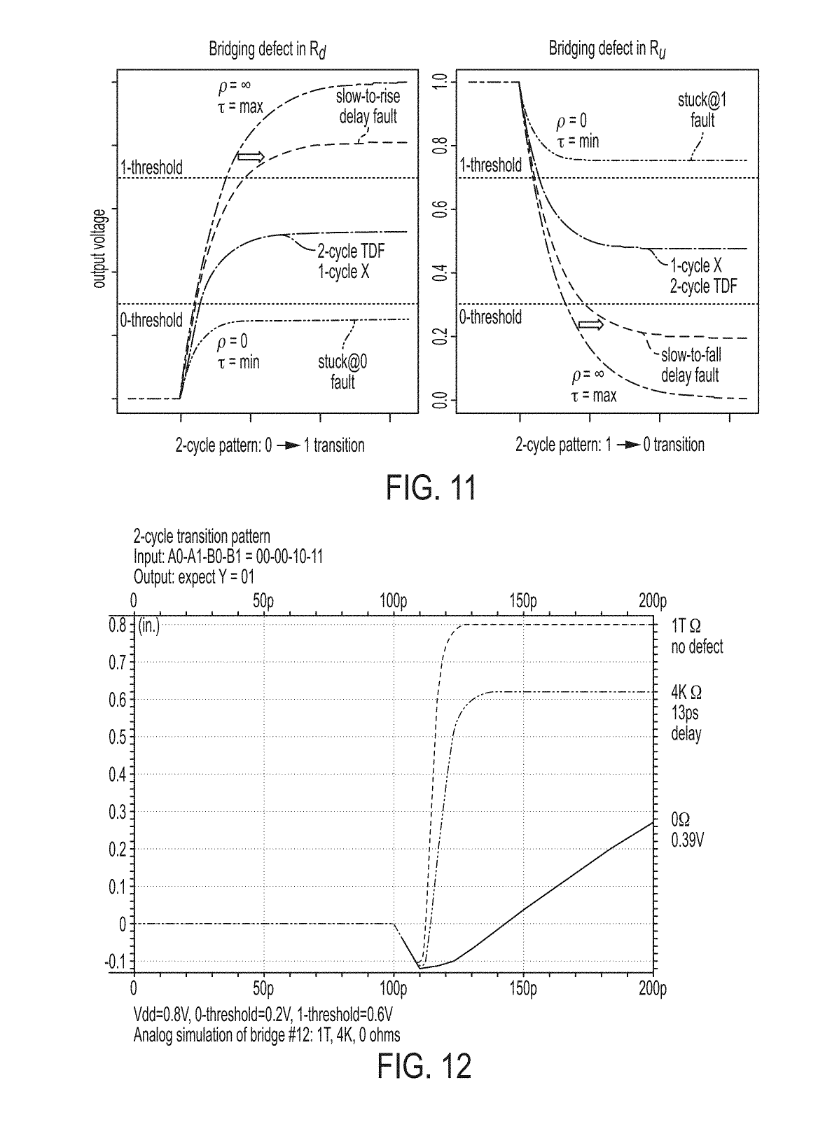

Plots of Vₒ(t) are shown for both cases in FIG. 11 as bridge resistance ρ varies from infinity (no defect) to zero (worst case) illustrating different degrees of impact. Based on CCN-short analysis, we can make the following key points:

K4—2-cycle TDF is the UDFM for all CCN-short defects that covers the full range of p starting from zero. 1-cycle SAF UDFM holds for a much limited p range.

K5—CCN-short defects can be detected by transition patterns targeting proxy switch stuck-closed faults. Since SL-ATPG generates a 1-cycle pattern for such faults, a prior initialization cycle needs to be added to create a transition pattern. Robust transition is unnecessary as the output is driven in both cycles.

K6—Only one analog simulation is needed with ρ=0 to determine if SAF UDFM is possible. V_{f} must fall below (rise above) 0-threshold (1-threshold) for SA0 (SA1). The gap between V_{f} and the threshold can be a metric for pattern ranking—larger is better.

For CCN-short, besides design context dependency at output capacitance C, receiving gates may have different digital interpretations of a V_{f} that lies between 0- and 1-thresholds. This is an issue only for 1-cycle SAF UDFM, but not for 2-cycle TDF because with the latter, any significant delay to reach expected 1 or 0 is sufficient for fault detection. FIG. 12 shows the result of analog simulation for a 2-cycle transition pattern to test AOI22 bridging fault #12 between nodes C and D in FIG. 5B. Three ρ ohmic values were tried: 12T for no defect, 4K, and zero (worst case). For 4K, V_{f} reached above the 1-threshold of 0.6V which maps to a TDF with extra delay of 13 ps. For the worst case, V_{f} eventually reaches 0.39V. Therefore, SA0 is disqualified for any value of ρ, but the defect can still be detected as a TDF.

### Section V.

### Conclusions

By circuit analysis, we showed how CCN defects can be easily characterized and detected by SL-ATPG without incurring expensive analog fault simulation. To deploy SL-ATPG for CAT view generation, it needs to be modified to search for all useful input conditions rather than the normal practice of “stop on first detect”. Early pruning in PODEM search means the generated UDFM can contain more don't-cares which should help reduce gate-level CAT pattern count. Finally, more efficient SL-ATPG opens up the opportunity to consider multiple cell-internal defects and generation of instance-specific CAT views based on design context.

### Additional Aspects

In some embodiments, techniques described herein may be carried out using one or more computing devices. Embodiments are not limited to operating with any particular type of computing device.

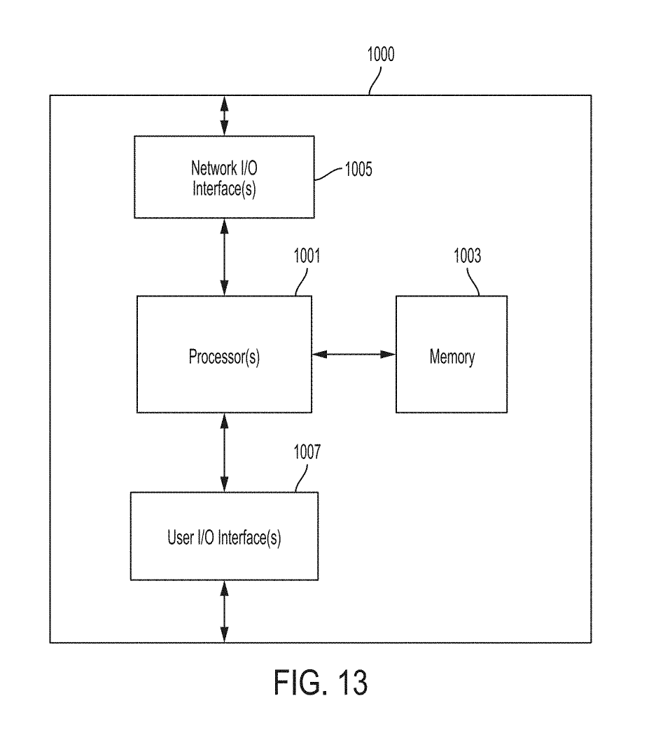

FIG. 13 is a block diagram of an illustrative computing device 1000. Computing device 1000 may include one or more processors 1001 and one or more tangible, non-transitory computer-readable storage media (e.g., memory 1003). Memory 1003 may store, in a tangible non-transitory computer-recordable medium, computer program instructions that, when executed, implement any of the above-described functionality. Processor(s) 1001 may be coupled to memory 1003 and may execute such computer program instructions to cause the functionality to be realized and performed.

Computing device 1000 may also include a network input/output (I/O) interface 1005 via which the computing device may communicate with other computing devices (e.g., over a network), and may also include one or more user I/O interfaces 1007, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments can be implemented in any of numerous ways. For example, the embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-discussed functions of one or more embodiments. The computer-readable medium may be transportable such that the program stored thereon can be loaded onto any computing device to implement aspects of the techniques discussed herein. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A circuit modeling method for automatic test pattern generation, the circuit modeling method comprising:
receiving an analog circuit representation of a circuit; and
producing a switch-level representation of the circuit by replacing analog circuit elements of the analog circuit representation with switches and modeling faults in the circuit as switches.

2. The circuit modeling method of claim 1, wherein the analog circuit representation comprises a netlist representing parasitics in the circuit with resistors and capacitors.

3. The circuit modeling method of claim 2, wherein replacing analog circuit elements of the analog circuit representation with switches comprises replacing at least one resistor with a closed switch and at least one capacitor with an open switch.

4. The circuit modeling method of claim 3, wherein modeling faults in the circuit as switches comprises modeling short-circuits as closed switches and modeling open circuits as open switches.

5. The circuit modeling method of claim 1, wherein modeling faults in the circuit as switches comprises modeling short-circuits as closed switches and modeling open circuits as open switches.

6. The circuit modeling method of claim 1, wherein automatic test pattern generation is performed using the switch-level representation of the circuit.

7. The circuit modeling method of claim 1, wherein the circuit comprises a digital circuit cell from a library of digital circuit cells.

8. A non-transitory computer readable storage medium having stored thereon instructions, which, when executed by a processor, perform a circuit modeling method for automatic test pattern generation, the circuit modeling method comprising:
receiving an analog circuit representation of a circuit; and
producing a switch-level representation of the circuit by replacing analog circuit elements of the analog circuit representation with switches and modeling faults in the circuit as switches.

9. The non-transitory computer readable storage medium of claim 8, wherein the analog circuit representation comprises a netlist representing parasitics in the circuit with resistors and capacitors.

10. The non-transitory computer readable storage medium of claim 9, wherein replacing analog circuit elements of the analog circuit representation with switches comprises replacing at least one resistor with a closed switch and at least one capacitor with an open switch.

11. The non-transitory computer readable storage medium of claim 10, wherein modeling faults in the circuit as switches comprises modeling short-circuits as closed switches and modeling open circuits as open switches.

12. The non-transitory computer readable storage medium of claim 8, wherein modeling faults in the circuit as switches comprises modeling short-circuits as closed switches and modeling open circuits as open switches.

13. The non-transitory computer readable storage medium of claim 8, wherein automatic test pattern generation is performed using the switch-level representation of the circuit.

14. An apparatus, comprising:
a processor; and
a non-transitory computer readable storage medium having stored thereon instructions, which, when executed by the processor, perform a circuit modeling method for automatic test pattern generation, the circuit modeling method comprising:
receiving an analog circuit representation of a circuit; and
producing a switch-level representation of the circuit by replacing analog circuit elements of the analog circuit representation with switches and modeling faults in the circuit as switches.

15. The apparatus of claim 14, wherein the analog circuit representation comprises a netlist representing parasitics in the circuit with resistors and capacitors.

16. The apparatus of claim 15, wherein replacing analog circuit elements of the analog circuit representation with switches comprises replacing at least one resistor with a closed switch and at least one capacitor with an open switch.

17. The apparatus of claim 16, wherein modeling faults in the circuit as switches comprises modeling short-circuits as closed switches and modeling open circuits as open switches.

18. The apparatus of claim 14, wherein modeling faults in the circuit as switches comprises modeling short-circuits as closed switches and modeling open circuits as open switches.

19. The apparatus of claim 14, wherein automatic test pattern generation is performed using the switch-level representation of the circuit.

20. The apparatus of claim 14, wherein the circuit comprises a digital circuit cell from a library of digital circuit cells.
